(19) United States
(12) Patent Application Publication
(10) Pub. No.: US 2006/0108322 A1
(43) Pub. Date: May 25, 2006

(54) Lift-off material

(76) Inventors: Wei Wu, Mountain View, CA (US); Zhiyong Li, Redwood City, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/993,451

(22) Filed: Nov. 19, 2004

(51) Int. Cl. B44C 1/22; B32B 27/00; C08L 33/00; B32B 3/00

(52) U.S. Cl. 216/40; 525/50

(57) ABSTRACT

A lift-off material for use in fabricating a nanostructure. The lift-off material includes a first material adapted to, and present in an amount sufficient to provide a predetermined amount of mechanical strength to the nanostructure during fabrication; and a second material adapted to, and present in an amount sufficient to provide a predetermined solubility to the lift-off material.

### BACKGROUND

The present disclosure relates generally to nanostructures, and more particularly to a lift-off material used in the fabrication of nanostructures.

Nano-imprint lithography was initiated as a process to achieve nanoscale features (about 100 nm or smaller) with high throughput and relatively low cost in structures such as, for example, molecular electronic devices. During the imprinting process, the nanoscale features are transferred from a mold to a polymer layer. The mold may be used for a thermal imprint process, as well as for a UV-based imprint process.

In the thermal imprint process, to deform the shape of the polymer, the temperature of the film and mold is generally higher than the glass transition temperature of the polymer, so that the polymer flows more easily to conform to the shape of the mold. Hydrostatic pressure may be used to press the mold into the polymer film, thus forming a replica of the mold in the polymer layer. The press is then cooled below the glass transition temperature to “freeze” the polymer and form a more rigid copy of the features in the mold. The mold is then removed from the substrate.

In the alternate UV imprint process, a UV-curable monomer solution is used instead of a thermoplastic polymer. The monomer layer is formed between the mold and the substrate. When exposed to a UV light, the monomer layer is polymerized to form a film with the desired patterns thereon. The UV-based nanoimprint process may generate patterns at room temperature with low pressure.

Some nano-imprinting techniques use a lift-off process or an etching process to transfer the pattern from the mold to the polymer layer. Generally, lift-off materials are highly soluble such that removal of such materials after the particular nanostructure is formed is as easy as dissolving the material. However, a potential problem with the techniques that use such highly soluble lift-off materials is the possible collapse of the nanostructure during fabrication. This may be due, in part, to the highly soluble lift-off material having relatively small mechanical strength to withstand imprinting, since high mechanical strength and desirable solubility are generally conflicting properties.

As such, it would be desirable to provide a lift-off material that provides mechanical strength during fabrication of the nanostructure, yet is easily removable after the fabrication of the nanostructure.

### SUMMARY

A lift-off material for use in fabricating a nanostructure is disclosed. The lift-off material includes a first material adapted to, and present in an amount sufficient to provide a predetermined amount of mechanical strength to the nanostructure during fabrication. The lift-off material also includes a second material adapted to, and present in an amount sufficient to provide a predetermined solubility to the lift-off material.

### BRIEF DESCRIPTION OF THE DRAWINGS

Objects, features and advantages will become apparent by reference to the following detailed description and drawings, in which like reference numerals correspond to similar, though not necessarily identical components. For the sake of brevity, reference numerals having a previously described function may not necessarily be described in connection with subsequent drawings in which they appear.

FIG. 1A is a schematic representation of two crossed wires, with at least one molecule at the intersection of the two wires;

FIG. 1B is a perspective elevational schematic view, depicting the crossed-wire device shown in FIG. 1A;

FIG. 2 is a schematic representation of a two-dimensional array of switches, depicting a 6×6 crossbar switch; and

FIGS. 3A through 3E schematically illustrate an embodiment of a method of forming a nanostructure using an embodiment of a lift-off material.

### DETAILED DESCRIPTION

Embodiments of the lift-off material as disclosed herein may be used in a variety of imprinting processes, including nanoimprint lithography processes used in the fabrication of nanostructures, such as, for example, molecular electronic structures. The lift-off material according to embodiments disclosed herein may advantageously have a mechanical strength that substantially prevents the collapse of the structure during fabrication. Further, embodiments of the lift-off material may advantageously be soluble in a suitable solvent such that, at the appropriate time, the lift-off material may be substantially easily removed.

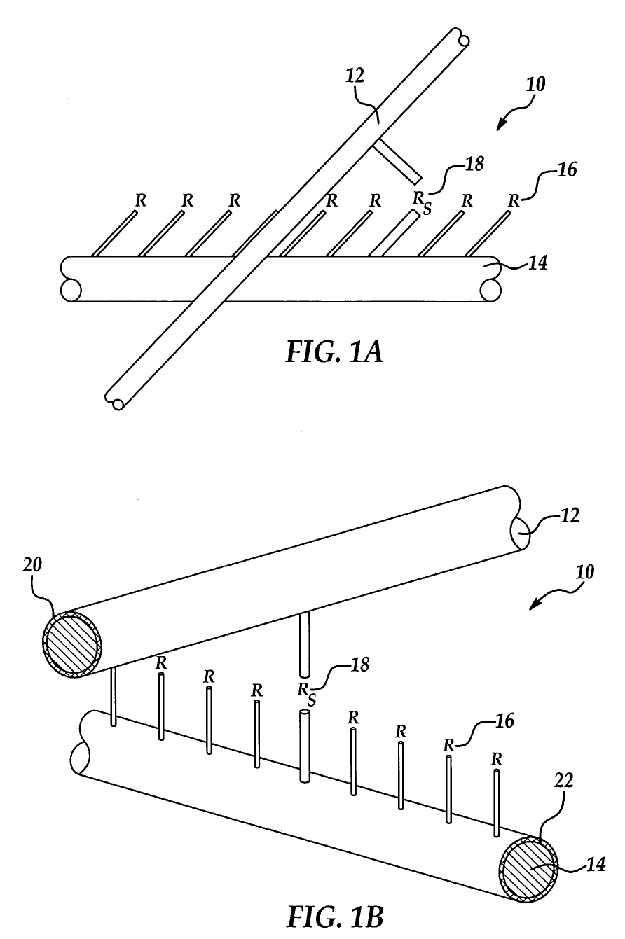

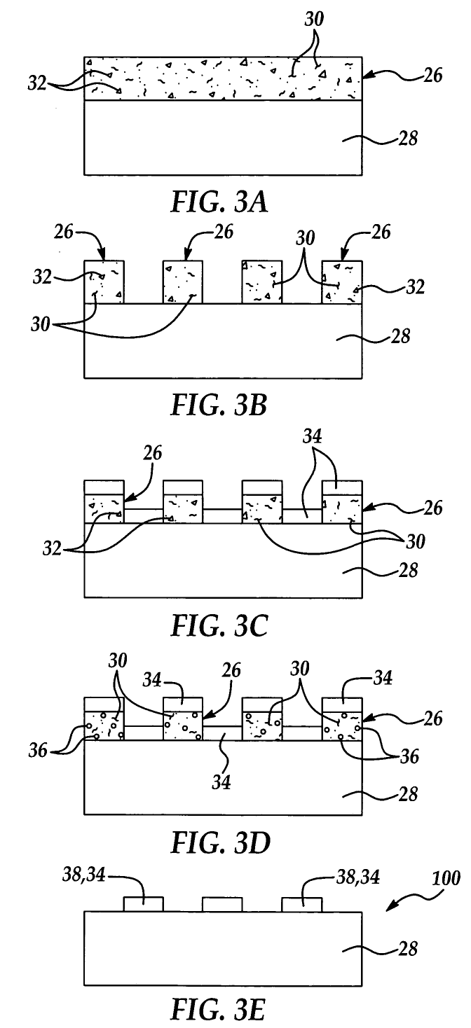

Referring now to FIGS. 1A-1B, a crossed wire switching device 10 includes two wires 12, 14, each either a metal or semiconductor wire, that are crossed at some substantially non-zero angle. It is to be understood that the crossed wire switching devices 10 as disclosed herein may be formed using embodiment(s) of the lift-off material 26 and method disclosed herein (as described in reference to FIGS. 3A through 3E). Disposed between wires 12, 14 is a layer 16 of molecules, molecular compounds, or mixtures thereof, denoted R. The particular molecules 18 that are sandwiched at the intersection (also interchangeably referred to herein as a junction) of the two wires 12, 14 are identified as switch molecules Rₛ. While wires 12, 14 are depicted as having substantially circular cross-sections in FIGS. 1A and 1B, it is to be understood that other cross-sectional geometries are contemplated as being within the purview of the present disclosure, such as, for example, ribbon-like geometries, substantially rectangular geometries, substantially square geometries, non-regular geometries, and the like.

There are generally two primary methods of operating such switches 10, depending on the nature of the switch molecules 18. The molecular switching layer 16 includes a switch molecule 18 (for example, an organic molecule) that, in the presence of an electrical (E) field, switches between two or more energetic states, such as by an electrochemical oxidation or reduction (redox) reaction or by a change in the band gap of the molecule induced by the applied E-field.

In the former case, when an appropriate voltage is applied across the wires 12, 14, the switch molecules R_{S} are either oxidized or reduced. When a molecule is oxidized (reduced), then a second species is reduced (oxidized) so that charge is balanced. These two species are then called a redox pair. One example of this device would be for one molecule to be reduced, and then a second molecule (the other half of the redox pair) would be oxidized. In another example, a molecule is reduced, and one of the wires 12, 14 is oxidized. In a third example, a molecule is oxidized, and one of the wires 12, 14 is reduced. In a fourth example, one wire 12, 14 is oxidized, and an oxide associated with the other wire 14, 12 is reduced. In such cases, oxidation or reduction may affect the tunneling distance or the tunneling barrier height between the two wires, thereby exponentially altering the rate of charge transport across the wire junction, and serving as the basis for a switch. Examples of molecules 18 that exhibit such redox behavior include rotaxanes, pseudo-rotaxanes, and catenanes; see, e.g., U.S. Pat. No. 6,459,095, entitled “Chemically Synthesized and Assembled Electronic Devices”, issued Oct. 1, 2002, to James R. Heath et al, the disclosure of which is incorporated herein by reference in its entirety.

Further, the wires 12, 14 may be modulation-doped by coating their surfaces with appropriate molecules—either electron-withdrawing groups (Lewis acids, such as boron trifluoride (BF₃)) or electron-donating groups (Lewis bases, such as alkylamines) to make them p-type or n-type conductors, respectively. FIG. 1B depicts a coating 20 on wire 12 and a coating 22 on wire 14. The coatings 20, 22 may be modulation-doping coatings, tunneling barriers (e.g., oxides), or other nano-scale functionally suitable materials. Alternatively, the wires 12, 14 themselves may be coated with one or more R species 16, and where the wires cross, Rₛ 18 is formed. Or yet alternatively, the wires 12, 14 may be coated with molecular species 20, 22, respectively, for example, that enable one or both wires to be suspended to form colloidal suspensions. Details of such coatings are provided in above-referenced U.S. Pat. No. 6,459,095.

In the latter case, examples of molecule 18 based on field induced changes include E-field induced band gap changes, such as disclosed and claimed in patent application Ser. No. 09/823,195, filed Mar. 29, 2001, published as Publication No. 2002/0176276 on Nov. 28, 2002, which application is incorporated herein by reference in its entirety. Examples of molecules used in the E-field induced band gap change approach include molecules that evidence molecular conformation change or an isomerization; change of extended conjugation via chemical bonding change to change the band gap; or molecular folding or stretching.

Changing of extended conjugation via chemical bonding change to change the band gap may be accomplished in one of the following ways: charge separation or recombination accompanied by increasing or decreasing band localization; or change of extended conjugation via charge separation or recombination and π-bond breaking or formation.

The formation of micrometer scale and nanometer scale crossed wire switches 10 uses either a reduction-oxidation (redox) reaction to form an electrochemical cell or uses E-field induced band gap changes to form molecular switches. In either case, the molecular switches typically have two states, and may be either irreversibly switched from a first state to a second state or reversibly switched from a first state to a second state. In the latter case, there are two possible conditions: either the electric field may be removed after switching into a given state, and the molecule will remain in that state (“latched”) until a reverse field is applied to switch the molecule back to its previous state; or removal of the electric field causes the molecule to revert to its previous state, and hence the field must be maintained in order to keep the molecule in the switched state until it is desired to switch the molecule to its previous state. It is to be understood that the switching mechanisms described hereinabove are illustrative examples, and are not meant to limit the scope of the present disclosure.

Color switch molecular analogs, particularly based on E-field induced band gap changes, are also known; see, e.g., U.S. Pat. No. 6,763,158, entitled “Molecular mechanical devices with a band gap change activated by an electric field for optical switching applications”, issued on Jul. 13, 2004, to Xiao-An Zhang et al., which is incorporated herein by reference in its entirety.

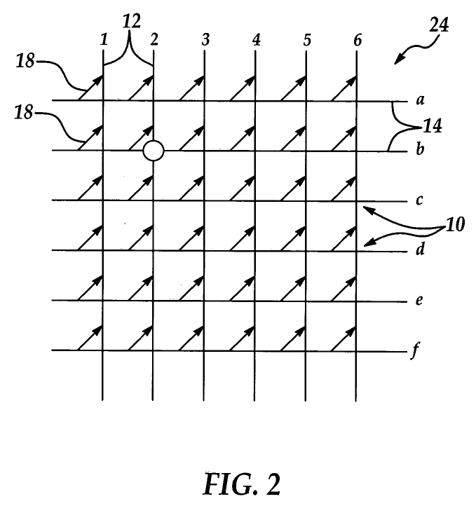

Referring now to FIG. 2, the switch 10 may be replicated in a two-dimensional array to form a plurality or array 24 of switches 10 to form a crossbar switch. FIG. 2 depicts a 6×6 array 24. However, it is to be understood that the embodiments herein are not to be limited to the particular number of elements, or switches 10, in the array 24. Access to a single point, e.g., 2b, is done by impressing voltage on wires 2 and b to cause a change in the state of the molecular species 18 at the junction thereof, as described above. Thus, access to each junction is readily available for configuring those that are pre-selected. Details of the operation of the crossbar switch array 24 are further discussed in U.S. Pat. No. 6,128,214, entitled “Molecular Wire Crossbar Memory”, issued on Oct. 3, 2000, to Philip J. Kuekes et al., which is incorporated herein by reference in its entirety.

FIGS. 3A through 3E depict an embodiment of the method of forming a (nano)structure 100 (non-limitative examples of which include molecular switching device 10 and bottom electrode 38) using an embodiment of the lift-off material 26 and the lift-off method. It is to be understood that the structure/nanostructure 100 as defined herein may be any or all of a fully functioning device/nanodevice, a semi-device/semi-nanodevice, or portion(s) of devices/nanodevices.

Referring now to FIG. 3A, an embodiment of the lift-off material 26 is established on a substrate 28. It is to be understood that any suitable substrate material may be used. In an embodiment, the substrate 28 is electrically insulating and includes, but is not limited to, an un-doped semiconductor, silicon nitride, amorphous silicon dioxide, crystalline silicon dioxide, sapphire, silicon carbide, diamond-like carbon, glass, silicon, silicon germanium, germanium, gallium arsenic, other Group III-V (in the Periodic Table) element semiconductor combinations, and the like, and mixtures thereof.

The lift-off material 26 includes a mixture of first and second materials 30, 32, both of which are soluble in a suitable solvent. However, it is to be understood that generally one of the materials 30, 32 provides a greater solubility (than does the other) to the lift-off material 26 during the nanostructure 100 fabrication, and thus is more soluble in the solvent than the other of the materials 32, 30.

Further, at least one of the first and second materials 30, 32 is adapted to provide a predetermined amount of mechanical strength to the nanostructure 100 during fabrication. It is to be understood that either one of the materials 30, 32 may exhibit the mechanical strength characteristic or the greater solubility characteristic. In the non-limitative embodiment referred to herein, the first material 30 exhibits greater mechanical strength than does the second material 32; and the second material 32 is more soluble in the solvent than is the first material 30.

In an embodiment, the first material 30 is present in the lift-off material 26 in an amount sufficient to provide a predetermined amount of mechanical strength to the nanostructure 100 as it is being fabricated. This amount may be dependant upon, for example, the properties of the material 30 that is selected. In an embodiment, the amount of first material 30 present in the lift-off material 26 ranges between about 50 weight % and about 90 weight %.

It is to be understood that mechanical strength may be measured by any suitable parameter or combination of parameters, including, but not limited to tensile strength, Young's modulus, toughness, and the like. In an embodiment, the first material 30 has a mechanical strength ranging between about 40 N/mm² and about 90 N/mm² of tensile strength. Some non-limitative examples of materials that may be used to provide such mechanical strength to the lift-off material 26 include 950 k PMMA (poly(methyl methacrylate)), high molecular weight aliphatic polyimide, high molecular weight polystyrene, high molecular weight polycarbonate, high molecular weight polyethylene, mixtures thereof, and the like. Without being bound to any theory, it is believed that the mechanical strength of the first material 30 advantageously substantially prevents the potential, undesirable collapse of the nanostructure 100 during fabrication.

In an embodiment, the second material 32 is present in the lift-off material 26 in an amount sufficient to provide a predetermined solubility to the lift-off material 26, thereby advantageously assisting in its quick removal after fabrication of the nanostructure 100. While both materials 30, 32 are soluble in the solvent used for removal, it is to be understood that generally the second material 32 is more soluble than the first material 30. In an embodiment, the solubility of the second material 32 ranges between about 5% (volumetric or weight ratio) and about 20% (volumetric or weight ratio), while the solubility of the first material 30 is less than that range. In an embodiment, the solubility of the first material 30 ranges between about 1% (volumetric or weight ratio) and about 10% (volumetric or weight ratio). Without being bound to any theory, it is believed that the greater solubility of the second material 32 increases the rate of dissolution of the lift-off material 26 (as described in more detail in reference to FIG. 3D).

Suitable non-limitative examples of the second material 32 include 15 k PMMA (poly(methyl methacrylate)), low molecular weight aliphatic polyimide, low molecular weight polystyrene, low molecular weight polycarbonate, low molecular weight polyethylene, mixtures thereof, and the like.

It is to be understood that generally the second material 32 (or, the more soluble material) is present in the lift-off material 26 in an amount that is less than that of the first material 30. For example, in one embodiment, the amount of second material 32 ranges between about 10 weight % and about 50 weight %, while the amount of first material 30 ranges between about 50 weight % and about 90 weight %. It is to be further understood that the second material 32 may be substantially homogeneously or heterogeneously mixed throughout the first material 30 to form the lift-off material 26. Further, area(s) of the first material 30 may have therein a heterogeneous mix of the second material 32, while other area(s) of the first material 30 may have therein a homogeneous mix of the second material 32.

As depicted in FIG. 3A, the lift-off material 26 is established on the substrate 28. In an embodiment of the lift-off method, the lift-off material 26 is established on the substrate 28 via a suitable deposition process. Non-limitative examples of suitable deposition processes include spin coating, drop casting, and the like, and combinations thereof.

Referring now to FIGS. 3B and 3C together, embodiments of a patterned lift-off material 26 and a deposited layer 34 on the patterned lift-off material 26 are respectively depicted. In an embodiment of nanostructure 100 fabrication, the lift-off material 26 may be patterned via a mold having nano features defined thereon (not shown), or any other suitable patterning process, such as, for example, etching. FIG. 3B illustrates the lift-off material 26 after it has been patterned. It is to be understood that the patterning may result in exposure of predetermined areas of the substrate 28, such that subsequently deposited materials may adhere thereto. FIG. 3C depicts an embodiment of a layer 34 being deposited on the patterned lift-off material 26 and on the exposed areas of the substrate 28. In a non-limitative example, the layer 34 is “blanket-deposited” on the lift-off material 26 and the substrate 28. The material used for the deposited layer 34 may be selected based on the nanostructure 100 that is being formed. In an embodiment, the layer 34 is made of a metal material or a semiconductor material that is suitable to form an electrode 38.

Referring now to FIG. 3D, an embodiment of the lift-off material 26 after being initially exposed to a solvent is depicted. It is to be understood that the selection of the solvent may be based, at least in part, on the materials used for the first and second materials 30, 32. Non-limitative examples of suitable solvents include acetone, tetrahydrofuran, and mixtures thereof.

Upon exposure to the solvent, the second material 32 (or more soluble material) begins to dissolve before the first material 30 (or mechanically strong material) begins to dissolve. The dissolution of the second material 32 forms transient pores 36 in the lift-off material 26. The transient pores 36 substantially increase the dissolution of the first material 30/remaining lift-off material 26. It is to be understood that substantially all of the lift-off material 26 is removed, and any layer 34 that is not adhered to the substrate 28 will also be removed, thereby leaving the remaining portion(s) of layer 34 adhered on the substrate 28.

FIG. 3E depicts the formed electrodes 38 on the substrate 28 after substantially all of the lift-off material 26 and non-adhered layer 34 are removed.

An example of a nanostructure 100 that may be formed by an embodiment of the method disclosed herein, and using embodiment(s) of the lift-off material 26 as disclosed herein, is a molecular switching device 10 (as shown in FIGS. 1A and 1B). The device 10 includes one or more bottom electrodes 14 formed by a process including establishing the lift-off material 26 on the substrate 28; patterning the lift-off material 26; depositing a layer 34 (e.g. a metal layer or a semiconductor layer) on the patterned lift-off material 26; and exposing the lift-off material 26 to a solvent, wherein the lift-off material 26 is removed, thereby forming one or more bottom electrodes 14. The device 10 also includes one or more top electrodes 12 crossing the bottom electrodes 14 substantially at a non-zero angle, thereby forming a junction. A molecular layer 16 is operatively disposed in the junction.

Embodiments of the lift-off material 26 and methods disclosed herein have many advantages, including, but not limited to the following. The lift-off material 26 according to embodiments disclosed herein may advantageously have a mechanical strength that substantially prevents the undesirable collapse of the structure 100 during its fabrication. Further, embodiments of the lift-off material 26 may advantageously be soluble in a suitable solvent such that after structure 100 fabrication, the lift-off material 26 may be substantially easily removed. Therefore, both mechanical strength and solubility may be achieved during imprinting and other (nano)structure fabrication processes.

While several embodiments have been described in detail, it will be apparent to those skilled in the art that the disclosed embodiments may be modified. Therefore, the foregoing description is to be considered exemplary rather than limiting.

What is claimed is:

1. A lift-off material for use in fabricating a nanostructure, the lift-off material comprising:
a first material adapted to, and present in an amount sufficient to provide a predetermined amount of mechanical strength to the nanostructure during fabrication; and
a second material adapted to, and present in an amount sufficient to provide a predetermined solubility to the lift-off material.

2. The lift-off material as defined in claim 1 wherein each of the first material and the second material are soluble in a solvent, and wherein the second material is more soluble in the solvent than the first material.

3. The lift-off material as defined in claim 1 wherein the mechanical strength of the first material ranges between 40 N/mm² and about 90 N/mm² of tensile strength.

4. The lift-off material as defined in claim 1 wherein the solubility of the second material ranges between about 5% and about 20%.

5. The lift-off material as defined in claim 1 wherein the first material comprises at least one of 950 k poly(methyl methacrylate), high molecular weight aliphatic polyimide, high molecular weight polystyrene, high molecular weight polycarbonate, high molecular weight polyethylene, and mixtures thereof.

6. The lift-off material as defined in claim 1 wherein the second material comprises at least one of 15 k poly(methyl methacrylate), low molecular weight aliphatic polyimide, low molecular weight polystyrene, low molecular weight polycarbonate, low molecular weight polyethylene, and mixtures thereof.

7. The lift-off material as defined in claim 1 wherein the amount of first material present in the lift-off material ranges between about 50 weight % and about 90 weight %.

8. The lift-off material as defined in claim 1 wherein the amount of the second material present in the lift-off material ranges between about 10 weight % and about 50 weight %.

9. The lift-off material as defined in claim 1 wherein the second material is at least one of substantially homogeneously and heterogeneously mixed throughout the first material.

10. A lift-off method for use during fabrication of a nanostructure, the lift-off method comprising:
establishing a lift-off material on a substrate, the lift-off material including a mixture of: one of a first material and a second material adapted to, and present in an amount sufficient to provide a predetermined amount of mechanical strength to the nanostructure during fabrication; and the other of the second material and the first material adapted to, and present in an amount sufficient to provide a predetermined solubility to the lift-off material during the nanostructure fabrication; and
exposing the lift-off material to a solvent, thereby causing the first and second materials to dissolve, wherein at least one of the first material and the second material dissolves substantially before the other of the second material and the first material such that transient pores are formed in the lift-off material, and wherein the transient pores substantially increase the dissolution of the other of the second material and the first material.

11. The lift-off method as defined in claim 10 wherein prior to exposing the lift-off material to the solvent, the method further comprises:
patterning the lift-off material; and
establishing a metal layer on the patterned lift-off material.

12. The lift-off method as defined in claim 10 wherein establishing the lift-off material on the substrate is accomplished by a deposition process.

13. The lift-off method as defined in claim 12 wherein the deposition process includes at least one of spin coating, drop casting, and combinations thereof.

14. The lift-off method as defined in claim 10 wherein the solvent is at least one of acetone, tetrahydrofuran, and mixtures thereof.

15. The lift-off method as defined in claim 10 wherein the first material provides the predetermined amount of mechanical strength, and wherein the predetermined amount of mechanical strength ranges between about 40 N/mm² and about 90 N/mm² of tensile strength.

16. The lift-off method as defined in claim 15 wherein the second material provides the predetermined solubility, and wherein the predetermined solubility ranges between about 5% and about 20%.

17. The lift-off method as defined in claim 10 wherein prior to establishing the the lift-off material on the substrate, the method further comprises mixing a predetermined amount of the first material with a predetermined amount of the second material, the predetermined amount of the first material ranging between about 50 weight % and about 90 weight % and the predetermined amount of the second material ranging between about 10 weight % and about 50 weight %.

18. The lift-off method as defined in claim 10 wherein the first material comprises at least one of 950 k poly(methyl methacrylate), high molecular weight aliphatic polyimide, high molecular weight polystyrene, high molecular weight polycarbonate, high molecular weight polyethylene, and mixtures thereof.

19. The lift-off method as defined in claim 10 wherein the second material comprises at least one of 15 k poly(methyl methacrylate), low molecular weight aliphatic polyimide, low molecular weight polystyrene, low molecular weight polycarbonate, low molecular weight polyethylene, and mixtures thereof.

20. The lift-off method as defined in claim 10 wherein each of the first material and the second material are soluble in the solvent, and wherein the second material is more soluble in the solvent than the first material.

21. A substrate for use in a process of fabricating a structure, the substrate comprising a lift-off material layer established on the substrate and adapted to be imprinted, the lift-off material layer including:
a first material adapted to, and present in an amount sufficient to provide a predetermined amount of mechanical strength to the structure during fabrication; and
a second material adapted to, and present in an amount sufficient to provide a predetermined solubility to the lift-off material.

22. The substrate as defined in claim 21 wherein the substrate is at least one of an un-doped semiconductor, silicon nitride, amorphous silicon dioxide, crystalline silicon dioxide, sapphire, silicon carbide, diamond-like carbon, glass, silicon, silicon germanium, germanium, gallium arsenic, other Group III-V element semiconductor combinations, and mixtures thereof.

23. The substrate as defined in claim 21 wherein each of the first material and the second material are soluble in a solvent, and wherein the second material is more soluble in the solvent than the first material.

24. The substrate as defined in claim 21 wherein the mechanical strength of the first material ranges between about 40 N/mm² and about 90 N/mm² of tensile strength.

25. The substrate as defined in claim 21 wherein the solubility of the second material ranges between about 5% and about 20%.

26. The substrate as defined in claim 21 wherein the first material comprises at least one of 950 k poly(methyl methacrylate), high molecular weight aliphatic polyimide, high molecular weight polystyrene, high molecular weight polycarbonate, high molecular weight polyethylene, and mixtures thereof.

27. The substrate as defined in claim 21 wherein the second material comprises at least one of 15 k poly(methyl methacrylate), low molecular weight aliphatic polyimide, low molecular weight polystyrene, low molecular weight polycarbonate, low molecular weight polyethylene, and mixtures thereof.

28. The substrate as defined in claim 21 wherein the amount of first material present in the lift-off material ranges between about 50 weight % and about 90 weight %.

29. The substrate as defined in claim 21 wherein the amount of the second material present in the lift-off material ranges between about 10 weight % and about 50 weight %.

30. A molecular switching device, comprising:
at least one bottom electrode formed by the process including:
establishing a lift-off material on a substrate, the lift-off material including a mixture of: one of a first material and a second material adapted to, and present in an amount sufficient to provide a predetermined amount of mechanical strength to the molecular switching device during fabrication; and the other of the second material and the first material adapted to, and present in an amount sufficient to provide a predetermined solubility to the lift-off material during the molecular switching device fabrication;
patterning the lift-off material;
depositing one of a metal layer and a semiconductor layer on the patterned lift-off material; and
exposing the lift-off material to a solvent, wherein at least one of the first material and the second material dissolves substantially before the other of the second material and the first material such that transient pores are formed in the lift-off material, wherein the transient pores substantially increase the dissolution of the other of the second material and the first material, and wherein the at least one bottom electrode is formed after dissolution of the first material and the second material;
at least one top electrode, the top electrode crossing the bottom electrode at a non-zero angle, thereby forming a junction; and
a molecular layer operatively disposed in the junction.

31. The molecular switching device as defined in claim 30 wherein establishing the lift-off material on the substrate is accomplished by a deposition process.

32. The molecular switching device as defined in claim 31 wherein the deposition process includes at least one of spin coating, drop casting, and combinations thereof.

33. The molecular switching device as defined in claim 30 wherein the solvent is at least one of acetone, tetrahydrofuran, and mixtures thereof.

34. The molecular switching device as defined in claim 30 wherein the first material provides the predetermined amount of mechanical strength, and wherein the predetermined amount of mechanical strength ranges between about 40 N/mm² and about 90 N/mm² of tensile strength.

35. The molecular switching device as defined in claim 30 wherein the second material provides the predetermined solubility, and wherein the predetermined solubility ranges between about 5% and about 20%.

36. The molecular switching device as defined in claim 30 wherein prior to establishing the lift-off material on the substrate, the process for forming the at least one bottom electrode further includes mixing a predetermined amount of the first material with a predetermined amount of the second material, the predetermined amount of the first material ranging between about 50 weight % and about 90 weight % and the predetermined amount of the second material ranging between about 10 weight % and about 50 weight %.

37. The molecular switching device as defined in claim 36 wherein the second material is at least one of substantially homogeneously mixed and heterogeneously mixed throughout the first material.

38. The molecular switching device as defined in claim 30 wherein the first material comprises at least one of 950 k poly(methyl methacrylate), high molecular weight aliphatic polyimide, high molecular weight polystyrene, high molecular weight polycarbonate, high molecular weight polyethylene, and mixtures thereof; and wherein the second material comprises at least one of 15 k poly(methyl methacrylate), low molecular weight aliphatic polyimide, low molecular weight polystyrene, low molecular weight polycarbonate, low molecular weight polyethylene, and mixtures thereof.

39. The molecular switching device as defined in claim 30 wherein each of the first material and the second material are soluble in the solvent, and wherein the second material is more soluble in the solvent than the first material.
